(19) United States
(12) Patent Application Publication
(10) Pub. No.: US 2024/0224205 A1
(43) Pub. Date: Jul. 4, 2024

(54) TIME SYNCHRONIZATION OVER CLOUD RADIO ACCESS NETWORKS

(71) Applicant: ALTIOSTAR NETWORKS, INC., Tewksbury, MA (US)

(72) Inventor: Ramana Reddy Machireddy, Bangalore (IN)

(21) Appl. No.: 17/792,605

(22) PCT Filed: Jul. 12, 2022
(86) PCT No.: PCT/US22/36816

§ 371 Date: Jul. 13, 2022

(30) Foreign Application Priority Data
May 27, 2022 (IN) 202241030545

(51) Int. Cl. H04W 56/00; H04J 3/06

(52) U.S. Cl. CPC H04W 56/0015; H04J 3/0667

(57) ABSTRACT

A method, a system, and a computer program product for performing clock synchronization in a wireless communication system. One or more communication parameters are received from one or more communication devices communicating in a wireless communication system. Based on the received one or more communication parameters, one or more synchronization parameters are determined for each of the one or more communication devices. The determined one or more synchronization parameters are provided to each of the one or more communication devices, and one or more communication devices are synchronized using provided one or more synchronization parameters.

### CROSS-REFERENCE TO RELATED APPLICATIONS

The present application claims priority to Indian Patent Appl. No. 202241030545 to Ramana Reddy Machireddy, filed May 27, 2022, and entitled “Time Synchronization Over Cloud Radio Access Networks”, and incorporates its disclosure herein by reference in its entirety.

### TECHNICAL FIELD

In some implementations, the current subject t matter relates to telecommunications systems, and in particular, to time synchronization over cloud radio access networks.

### BACKGROUND

In today's world, cellular networks provide on-demand communications capabilities to individuals and business entities. Typically, a cellular network is a wireless network that can be distributed over land areas, which are called cells. Each such cell is served by at least one fixed-location transceiver, which is referred to as a cell site or a base station. Each cell can use a different set of frequencies than its neighbor cells in order to avoid interference and provide improved service within each cell. When cells are joined together, they provide radio coverage over a wide geographic area, which enables a large number of mobile telephones, and/or other wireless devices or portable transceivers to communicate with each other and with fixed transceivers and telephones anywhere in the network. Such communications are performed through base stations and are accomplished even if the mobile transceivers are moving through more than one cell during transmission. Major wireless communications providers have deployed such cell sites throughout the world, thereby allowing communications mobile phones and mobile computing devices to be connected to the public switched telephone network and public Internet.

A mobile telephone is a portable telephone that is capable of receiving and/or making telephone and/or data calls through a cell site or a transmitting tower by using radio waves to transfer signals to and from the mobile telephone. In view of a large number of mobile telephone users, current mobile telephone networks provide a limited and shared resource. In that regard, cell sites and handsets can change frequency and use low power transmitters to allow simultaneous usage of the networks by many callers with less interference. Coverage by a cell site can depend on a particular geographical location and/or a number of users that can potentially use the network. For example, in a city, a cell site can have a range of up to approximately ½ mile; in rural areas, the range can be as much as 5 miles; and in some areas, a user can receive signals from a cell site 25 miles away.

The following are examples of some of the digital cellular technologies that are in use by the communications providers: Global System for Mobile Communications (“GSM”), General Packet Radio Service (“GPRS”), cdmaOne, CDMA2000, Evolution-Data Optimized (“EV-DO”), Enhanced Data Rates for GSM Evolution (“EDGE”), Universal Mobile Telecommunications System (“UMTS”), Digital Enhanced Cordless Telecommunications (“DECT”), Digital AMPS (“IS-136/TDMA”), and Integrated Digital Enhanced Network (“iDEN”). The Long Term Evolution, or 4G LTE, which was developed by the Third Generation Partnership Project (“3GPP”) standards body, is a standard for a wireless communication of high-speed data for mobile phones and data terminals. A 5G standard is currently being developed and deployed. 3GPP cellular technologies like LTE and 5G NR are evolutions of earlier generation 3GPP technologies like the GSM/EDGE and UMTS/HSPA digital cellular technologies and allows for increasing capacity and speed by using a different radio interface together with core network improvements.

Cellular networks can be divided into radio access networks and core networks. The radio access network (RAN) can include network functions that can handle radio layer communications processing. The core network can include network functions that can handle higher layer communications, e.g., internet protocol (IP), transport layer and applications layer. In some cases, the RAN functions can be split into baseband unit functions and the radio unit functions, where a radio unit connected to a baseband unit via a fronthaul network, for example, can be responsible for lower layer processing of a radio physical layer while a baseband unit can be responsible for the higher layer radio protocols, e.g., MAC, RLC, etc.

To ensure proper efficient and proper functioning of the air interface, communications networks implement various frequency and timing requirements. However, currently implemented protocols are not capable of providing effective synchronization of timing to base stations.

### SUMMARY

In some implementations, the current subject matter relates to a computer implemented method for performing clock synchronization in a wireless communication system (e.g., a cloud-based radio access network). The method may include receiving, using at least one processor, one or more communication parameters from one or more communication devices communicating in a wireless communication system, determining, based on the received one or more communication parameters, one or more synchronization parameters for each of the one or more communication devices, and providing the determined one or more synchronization parameters to each of the one or more communication devices, and synchronizing the one or more communication devices using the provided one or more synchronization parameters.

In some implementations, the current subject matter may include one or more of the following optional features. One or more communication parameters may include one or more timestamps associated with one or more synchronization packets generated by one or more communication devices, one or more timestamps being extracted from one or more synchronization packets by one or more communication devices. One or more communication parameters may include one or more control data packets associated with controlling operation of the one or more communication devices. One or more control data packets may be extracted from at least one of: one or more precision timing protocol data packets generated by one or more communication devices, one or more synchronous Ethernet data packets generated by one or more communication devices, and any combination thereof.

In some implementations, one or more synchronization parameters may include at least one of the following: a phase, a frequency, a timing offset and any combination thereof associated with each of one or more communication devices.

In some implementations, the method may also include determining a sector status of one or more communication devices based on determined one or more synchronization parameters.

In some implementations, one or more communication devices may be configured to transmit one or more data packets based on the synchronizing.

In some implementations, one or more communication devices may include at least one of the following: a base station, a gNodeB base station, an eNodeB base station, and any combination thereof. One or more communication devices may include at least one of the following: one or more distributed units, one or more radio units, and any combinations thereof. The base station may be a base station operating in at least one of the following communications systems: a long term evolution communications system and a new radio communications system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary conventional long term evolution (“LTE”) communications system;

FIG. 1b illustrates further detail of the exemplary LTE system shown in FIG. 1a;

FIG. 1c illustrates additional detail of the evolved packet core of the exemplary LTE system shown in FIG. 1a;

FIG. 1d illustrates an exemplary evolved Node B of the exemplary LTE system shown in FIG. 1a;

FIG. 2 illustrates further detail of an evolved Node B shown in FIGS. 1a-d;

FIG. 3 illustrates an exemplary virtual radio access network, according to some implementations of the current subject matter;

FIG. 4 illustrates an exemplary 3GPP split architecture to provide its users with use of higher frequency bands;

FIG. 5a illustrates an exemplary 5G wireless communication system;

FIG. 5b illustrates an exemplary layer architecture of the split gNB and/or a split ng-eNB (e.g., next generation eNB that may be connected to 5GC);

FIG. 5c illustrates an exemplary functional split in the gNB architecture shown in FIGS. 5a-b;

FIG. 6 illustrates an exemplary clock synchronization process;

FIG. 7 illustrates an exemplary system that performs distribution and processing associated with clock/timing synchronization across various communication devices;

FIG. 8 illustrates an exemplary distributed unit and its synchronization components;

FIG. 9 illustrates an exemplary synchronization system, according to some implementations of the current subject matter;

FIG. 10 illustrates an exemplary system, according to some implementations of the current subject matter; and

FIG. 11 illustrates an exemplary method, according to some implementations of the current subject matter.

### DETAILED DESCRIPTION

The current subject matter can provide for systems and methods that can be implemented in wireless communications systems. Such systems can include various wireless communications systems, including 5G New Radio communications systems, long term evolution communication systems, etc.

In some implementations, the current subject matter relates to performing time/phase/frequency synchronization over cloud radio access networks. In particular, the current subject matter may be configured to provide a controller device that may be communicatively coupled to one or more communication devices, such as one or more distributed units, using a synchronization interface. Using such synchronization interface, the controller may be configured to receive one or more communication parameters from one or more communication devices (e.g., distributed units) communicating in a wireless communication system, e.g., a cloud radio access network. The parameters may include one or more timestamps associated with synchronization packets transmitted by the communication devices and/or various control information. The controller may be hosted on a remote server that may include one or more servos (e.g., synchronization servos).

Based on the received parameters, the controller may be configured to determine one or more synchronization parameters for each of communication device communicatively coupled to the controller. For example, the controller may be configured to determine one or more offset parameters, such as, phase offset and/or frequency offset.

Once such time, phase and/or frequency offsets are determined, the controller may be configured to provide and/or transmit the offsets to the communication devices, e.g., distributed units, and use the determined offsets to synchronize the communication devices.

One or more aspects of the current subject matter can be incorporated into transmitter and/or receiver components of base stations (e.g., gNodeBs, eNodeBs, etc.) in such communications systems. The following is a general discussion of long-term evolution communications systems and 5G New Radio communication systems.

### I. Long Term Evolution Communications System

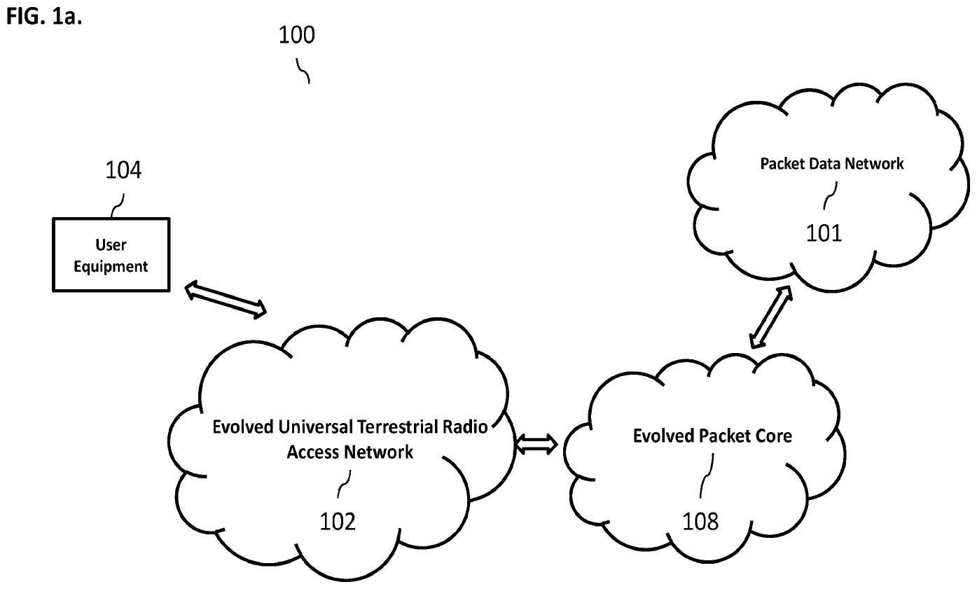

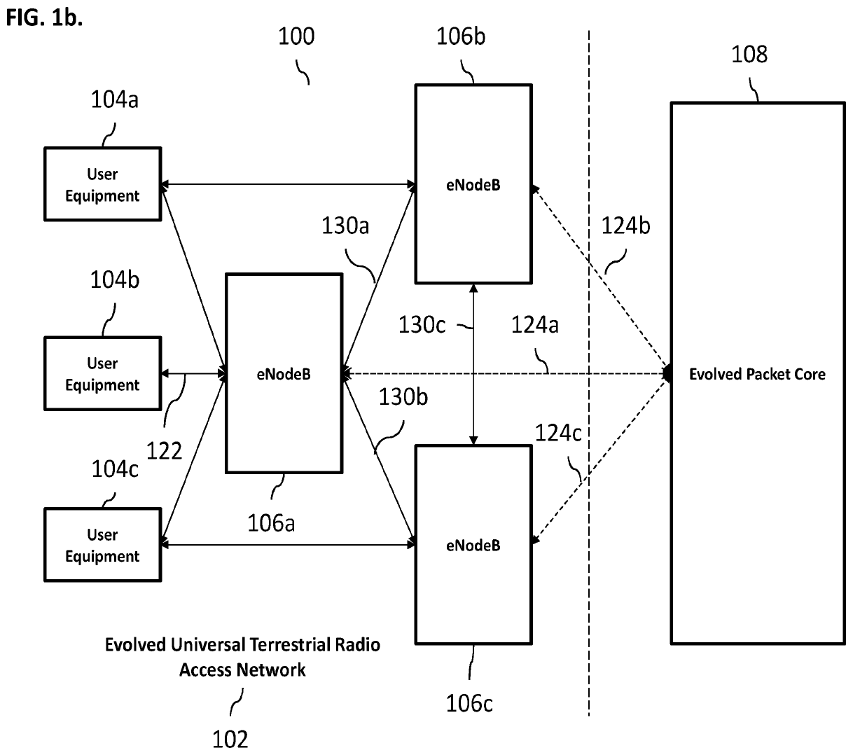

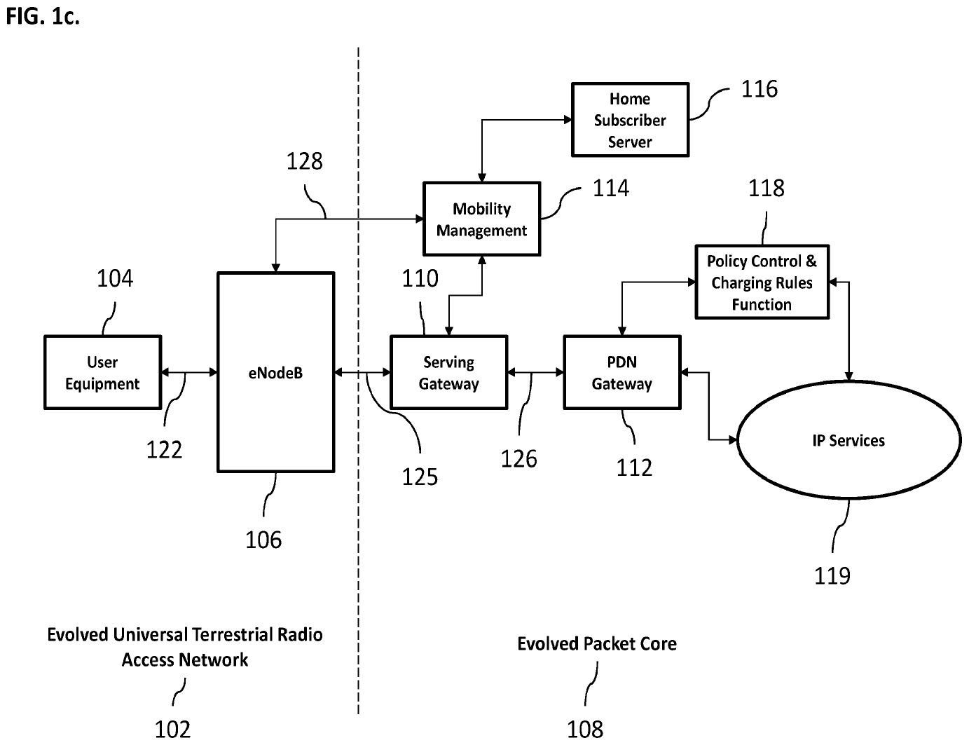

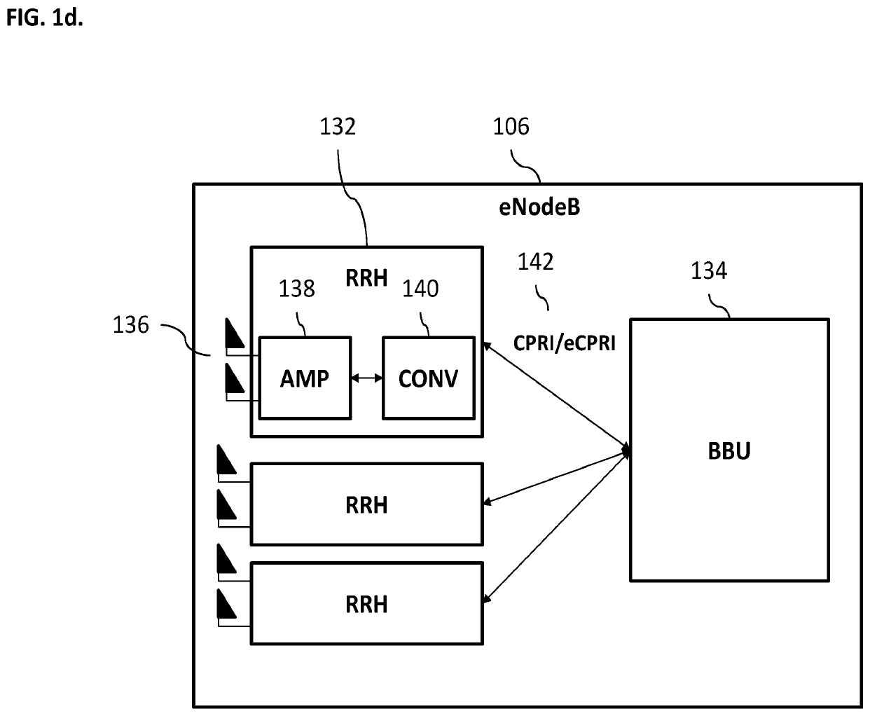

FIGS. 1a-c and 2 illustrate an exemplary conventional long-term evolution (“LTE”) communication system 100 along with its various components. An LTE system or a 4G LTE, as it is commercially known, is governed by a standard for wireless communication of high-speed data for mobile telephones and data terminals. The standard is an evolution of the GSM/EDGE (“Global System for Mobile Communications”/“Enhanced Data rates for GSM Evolution”) as well as UMTS/HSPA (“Universal Mobile Telecommunications System”/“High Speed Packet Access”) network technologies. The standard was developed by the 3GPP (“3rd Generation Partnership Project”).

As shown in FIG. 1a, the system 100 can include an evolved universal terrestrial radio access network (“EUTRAN”) 102, an evolved packet core (“EPC”) 108, and a packet data network (“PDN”) 101, where the EUTRAN 102 and EPC 108 provide communication between a user equipment 104 and the PDN 101. The EUTRAN 102 can include a plurality of evolved node B's (“eNodeB” or “ENODEB” or “enodeb” or “eNB”) or base stations 106 (a, b, c) (as shown in FIG. 1b) that provide communication capabilities to a plurality of user equipment 104(a, b, c). The user equipment 104 can be a mobile telephone, a smartphone, a tablet, a personal computer, a personal digital assistant (“PDA”), a server, a data terminal, and/or any other type of user equipment, and/or any combination thereof. The user equipment 104 can connect to the EPC 108 and eventually, the PDN 101, via any eNodeB 106. Typically, the user equipment 104 can connect to the nearest, in terms of distance, eNodeB 106. In the LTE system 100, the EUTRAN 102 and EPC 108 work together to provide connectivity, mobility and services for the user equipment 104.

FIG. 1b illustrates further detail of the network 100 shown in FIG. 1a. As stated above, the EUTRAN 102 includes a plurality of eNodeBs 106, also known as cell sites. The eNodeBs 106 provides radio functions and performs key control functions including scheduling of air link resources or radio resource management, active mode mobility or handover, and admission control for services. The eNodeBs 106 are responsible for selecting which mobility management entities (MMEs, as shown in FIG. 1c) will serve the user equipment 104 and for protocol features like header compression and encryption. The eNodeBs 106 that make up an EUTRAN 102 collaborate with one another for radio resource management and handover.

Communication between the user equipment 104 and the eNodeB 106 occurs via an air interface 122 (also known as “LTE-Uu” interface). As shown in FIG. 1b, the air interface 122 provides communication between user equipment 104b and the eNodeB 106a. The air interface 122 uses Orthogonal Frequency Division Multiple Access (“OFDMA”) and Single Carrier Frequency Division Multiple Access (“SC-FDMA”), an OFDMA variant, on the downlink and uplink respectively. OFDMA allows use of multiple known antenna techniques, such as, Multiple Input Multiple Output (“MIMO”).

The air interface 122 uses various protocols, which include a radio resource control (“RRC”) for signaling between the user equipment 104 and eNodeB 106 and non-access stratum (“NAS”) for signaling between the user equipment 104 and MME (as shown in FIG. 1c). In addition to signaling, user traffic is transferred between the user equipment 104 and eNodeB 106. Both signaling and traffic in the system 100 are carried by physical layer (“PHY”) channels.

Multiple eNodeBs 106 can be interconnected with one another using an X2 interface 130(a, b, c). As shown in FIG. 1a, X2 interface 130a provides interconnection between eNodeB 106a and eNodeB 106b; X2 interface 130b provides interconnection between eNodeB 106a and eNodeB 106c; and X2 interface 130c provides interconnection between eNodeB 106b and eNodeB 106c. The X2 interface can be established between two eNodeBs in order to provide an exchange of signals, which can include a load- or interference-related information as well as handover-related information. The eNodeBs 106 communicate with the evolved packet core 108 via an S1 interface 124(a, b, c). The S1 interface 124 can be split into two interfaces: one for the control plane (shown as control plane interface (S1-MME interface) 128 in FIG. 1c) and the other for the user plane (shown as user plane interface (S1-U interface) 125 in FIG. 1c).

The EPC 108 establishes and enforces Quality of Service (“QoS”) for user services and allows user equipment 104 to maintain a consistent internet protocol (“IP”) address while moving. It should be noted that each node in the network 100 has its own IP address. The EPC 108 is designed to interwork with legacy wireless networks. The EPC 108 is also designed to separate control plane (i.e., signaling) and user plane (i.e., traffic) in the core network architecture, which allows more flexibility in implementation, and independent scalability of the control and user data functions.

The EPC 108 architecture is dedicated to packet data and is shown in more detail in FIG. 1c. The EPC 108 includes a serving gateway (S-GW) 110, a PDN gateway (P-GW) 112, a mobility management entity (“MME”) 114, a home subscriber server (“HSS”) 116 (a subscriber database for the EPC 108), and a policy control and charging rules function (“PCRF”) 118. Some of these (such as S-GW, P-GW, MME, and HSS) are often combined into nodes according to the manufacturer's implementation.

The S-GW 110 functions as an IP packet data router and is the user equipment's bearer path anchor in the EPC 108. Thus, as the user equipment moves from one eNodeB 106 to another during mobility operations, the S-GW 110 remains the same and the bearer path towards the EUTRAN 102 is switched to talk to the new eNodeB 106 serving the user equipment 104. If the user equipment 104 moves to the domain of another S-GW 110, the MME 114 will transfer all of the user equipment's bearer paths to the new S-GW. The S-GW 110 establishes bearer paths for the user equipment to one or more P-GWs 112. If downstream data are received for an idle user equipment, the S-GW 110 buffers the downstream packets and requests the MME 114 to locate and reestablish the bearer paths to and through the EUTRAN 102.

The P-GW 112 is the gateway between the EPC 108 (and the user equipment 104 and the EUTRAN 102) and PDN 101 (shown in FIG. 1a). The P-GW 112 functions as a router for user traffic as well as performs functions on behalf of the user equipment. These include IP address allocation for the user equipment, packet filtering of downstream user traffic to ensure it is placed on the appropriate bearer path, enforcement of downstream QoS, including data rate. Depending upon the services a subscriber is using, there may be multiple user data bearer paths between the user equipment 104 and P-GW 112. The subscriber can use services on PDNs served by different P-GWs, in which case the user equipment has at least one bearer path established to each P-GW 112. During handover of the user equipment from one eNodeB to another, if the S-GW 110 is also changing, the bearer path from the P-GW 112 is switched to the new S-GW.

The MME 114 manages user equipment 104 within the EPC 108, including managing subscriber authentication, maintaining a context for authenticated user equipment 104, establishing data bearer paths in the network for user traffic, and keeping track of the location of idle mobiles that have not detached from the network. For idle user equipment 104 that needs to be reconnected to the access network to receive downstream data, the MME 114 initiates paging to locate the user equipment and re-establishes the bearer paths to and through the EUTRAN 102. MME 114 for a particular user equipment 104 is selected by the eNodeB 106 from which the user equipment 104 initiates system access. The MME is typically part of a collection of MMEs in the EPC 108 for the purposes of load sharing and redundancy. In the establishment of the user's data bearer paths, the MME 114 is responsible for selecting the P-GW 112 and the S-GW 110, which will make up the ends of the data path through the EPC 108.

The PCRF 118 is responsible for policy control decision-making, as well as for controlling the flow-based charging functionalities in the policy control enforcement function (“PCEF”), which resides in the P-GW 110. The PCRF 118 provides the QoS authorization (QOS class identifier (“QCI”) and bit rates) that decides how a certain data flow will be treated in the PCEF and ensures that this is in accordance with the user's subscription profile.

As stated above, the IP services 119 are provided by the PDN 101 (as shown in FIG. 1a).

FIG. 1d illustrates an exemplary structure of eNodeB 106. The eNodeB 106 can include at least one remote radio head (“RRH”) 132 (typically, there can be three RRH 132) and a baseband unit (“BBU”) 134. The RRH 132 can be connected to antennas 136. The RRH 132 and the BBU 134 can be connected using an optical interface that is compliant with common public radio interface (“CPRI”)/enhanced CPRI (“eCPRI”) 142 standard specification either using RRH specific custom control and user plane framing methods or using O-RAN Alliance compliant Control and User plane framing methods. The operation of the eNodeB 106 can be characterized using the following standard parameters (and specifications): radio frequency band (Band4, Band9, Band17, etc.), bandwidth (5, 10, 15, 20 MHz), access scheme (downlink: OFDMA; uplink: SC-OFDMA), antenna technology (Single user and multi user MIMO; Uplink: Single user and multi user MIMO), number of sectors (6 maximum), maximum transmission rate (downlink: 150 Mb/s; uplink: 50 Mb/s), S1/X2 interface (1000Base-SX, 1000Base-T), and mobile environment (up to 350 km/h). The BBU 134 can be responsible for digital baseband signal processing, termination of S1 line, termination of X2 line, call processing and monitoring control processing. IP packets that are received from the EPC 108 (not shown in FIG. 1d) can be modulated into digital baseband signals and transmitted to the RRH 132. Conversely, the digital baseband signals received from the RRH 132 can be demodulated into IP packets for transmission to EPC 108.

The RRH 132 can transmit and receive wireless signals using antennas 136. The RRH 132 can convert (using converter (“CONV”) 140) digital baseband signals from the BBU 134 into radio frequency (“RF”) signals and power amplify (using amplifier (“AMP”) 138) them for transmission to user equipment 104 (not shown in FIG. 1d). Conversely, the RF signals that are received from user equipment 104 are amplified (using AMP 138) and converted (using CONV 140) to digital baseband signals for transmission to the BBU 134.

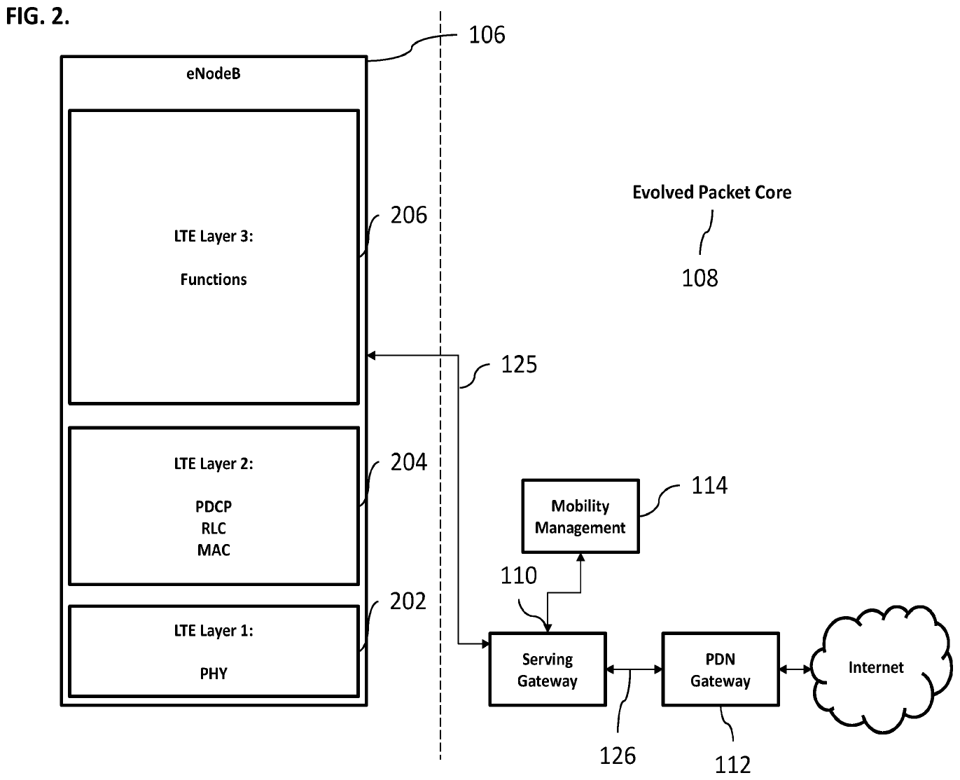

FIG. 2 illustrates an additional detail of an exemplary eNodeB 106. The eNodeB 106 includes a plurality of layers: LTE layer 1 202, LTE layer 2 204, and LTE layer 3 206. The LTE layer 1 includes a physical layer (“PHY”). The LTE layer 2 includes a medium access control (“MAC”), a radio link control (“RLC”), a packet data convergence protocol (“PDCP”). The LTE layer 3 includes various functions and protocols, including a radio resource control (“RRC”), a dynamic resource allocation, eNodeB measurement configuration and provision, a radio admission control, a connection mobility control, and radio resource management (“RRM”). The RLC protocol is an automatic repeat request (“ARQ”) fragmentation protocol used over a cellular air interface. The RRC protocol handles control plane signaling of LTE layer 3 between the user equipment and the EUTRAN. RRC includes functions for connection establishment and release, broadcast of system information, radio bearer establishment/reconfiguration and release, RRC connection mobility procedures, paging notification and release, and outer loop power control. The PDCP performs IP header compression and decompression, transfer of user data and maintenance of sequence numbers for Radio Bearers. The BBU 134, shown in FIG. 1d, can include LTE layers L1-L3.

One of the primary functions of the eNodeB 106 is radio resource management, which includes scheduling of both uplink and downlink air interface resources for user equipment 104, control of bearer resources, and admission control. The eNodeB 106, as an agent for the EPC 108, is responsible for the transfer of paging messages that are used to locate mobiles when they are idle. The eNodeB 106 also communicates common control channel information over the air, header compression, encryption and decryption of the user data sent over the air, and establishing handover reporting and triggering criteria. As stated above, the eNodeB 106 can collaborate with other eNodeB 106 over the X2 interface for the purposes of handover and interference management. The eNodeBs 106 communicate with the EPC's MME via the S1-MME interface and to the S-GW with the S1-U interface. Further, the eNodeB 106 exchanges user data with the S-GW over the S1-U interface. The eNodeB 106 and the EPC 108 have a many-to-many relationship to support load sharing and redundancy among MMEs and S-GWs. The eNodeB 106 selects an MME from a group of MMEs so the load can be shared by multiple MMEs to avoid congestion.

### II. 5G NR Wireless Communications Networks

In some implementations, the current subject matter relates to a 5G new radio (“NR”) communications system. The 5G NR is a next telecommunications standard beyond the 4G/IMT-Advanced standards. 5G networks offer at higher capacity than current 4G, allow higher number of mobile broadband users per area unit, and allow consumption of higher and/or unlimited data quantities in gigabyte per month and user. This can allow users to stream high-definition media many hours per day using mobile devices, even when it is not possible to do so with Wi-Fi networks. 5G networks have an improved support of device-to-device communication, lower cost, lower latency than 4G equipment and lower battery consumption, etc. Such networks have data rates of tens of megabits per second for a large number of users, data rates of 100 Mb/s for metropolitan areas, 1 Gb/s simultaneously to users within a confined area (e.g., office floor), a large number of simultaneous connections for wireless sensor networks, an enhanced spectral efficiency, improved coverage, enhanced signaling efficiency, 1-10 ms latency, reduced latency compared to existing systems.

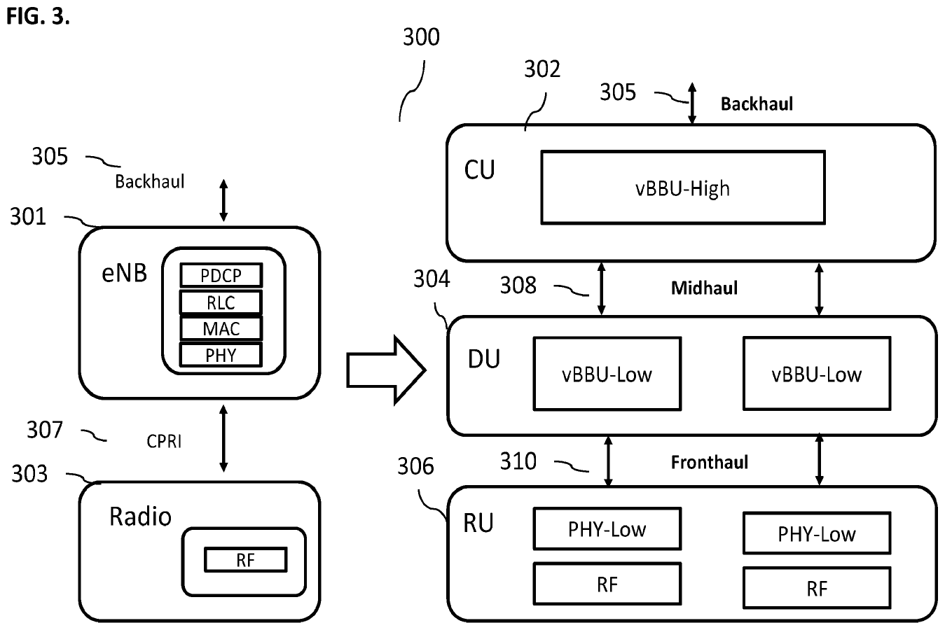

FIG. 3 illustrates an exemplary virtual radio access network 300. The network 300 can provide communications between various components, including a base station (e.g., eNodeB, gNodeB) 301, a radio equipment 307, a centralized unit 302, a digital unit 304, and a radio device 306. The components in the system 300 can be communicatively coupled to a core using a backhaul link 305. A centralized unit (“CU”) 302 can be communicatively coupled to a distributed unit (“DU”) 304 using a midhaul connection 308. The radio frequency (“RU”) components 306 can be communicatively coupled to the DU 304 using a fronthaul connection 310.

In some implementations, the CU 302 can provide intelligent communication capabilities to one or more DU units 308. The units 302, 304 can include one or more base stations, macro base stations, micro base stations, remote radio heads, etc. and/or any combination thereof.

In lower layer split architecture environment, a CPRI bandwidth requirement for NR can be 100s of Gb/s. CPRI compression can be implemented in the DU and RU (as shown in FIG. 3). In 5G communications systems, compressed CPRI over Ethernet frame is referred to as eCPRI and is the recommended fronthaul network. The architecture can allow for standardization of fronthaul/midhaul, which can include a higher layer split (e.g., Option 2 or Option 3-1 (Upper/Lower RLC split architecture)) and fronthaul with L1-split architecture (Option 7).

In some implementations, the lower layer-split architecture (e.g., Option 7) can include a receiver in the uplink, joint processing across multiple transmission points (TPs) for both DL/UL, and transport bandwidth and latency requirements for ease of deployment. Further, the current subject matter's lower layer-split architecture can include a split between cell-level and user-level processing, which can include cell-level processing in remote unit (“RU”) and user-level processing in DU. Further, using the current subject matter's lower layer-split architecture, frequency-domain samples can be transported via Ethernet fronthaul, where the frequency-domain samples can be compressed for reduced fronthaul bandwidth.

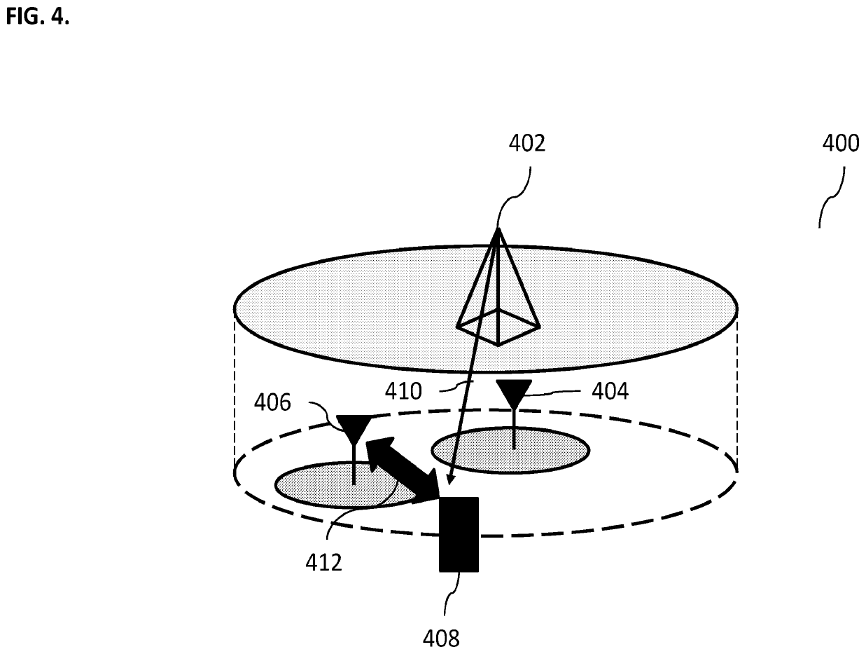

FIG. 4 illustrates an exemplary communications system 400 that can implement a 5G technology and can provide its users with use of higher frequency bands (e.g., greater than 10 GHz). The system 400 can include a macro cell 402 and small cells 404 and 406.

A mobile device 408 can be configured to communicate with one or more of the small cells 404, 406. The system 400 can allow splitting of control planes (C-plane) and user planes (U-plane) between the macro cell 402 and small cells 404, 406, where the C-plane and U-plane are utilizing different frequency bands. In particular, the small cells 402, 404 can be configured to utilize higher frequency bands when communicating with the mobile device 408. The macro cell 402 can utilize existing cellular bands for C-plane communications. The mobile device 408 can be communicatively coupled via U-plane 412, where the small cell (e.g., small cell 406) can provide higher data rate and more flexible/cost/energy efficient operations. The macro cell 402, via C-plane 410, can maintain good connectivity and mobility. Further, in some cases, LTE and NR can be transmitted on the same frequency.

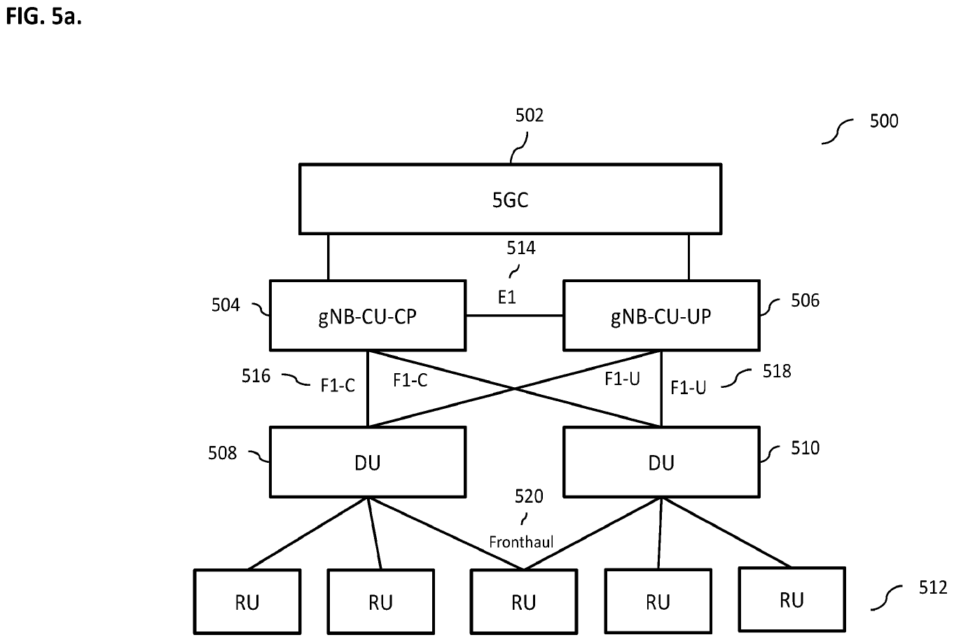

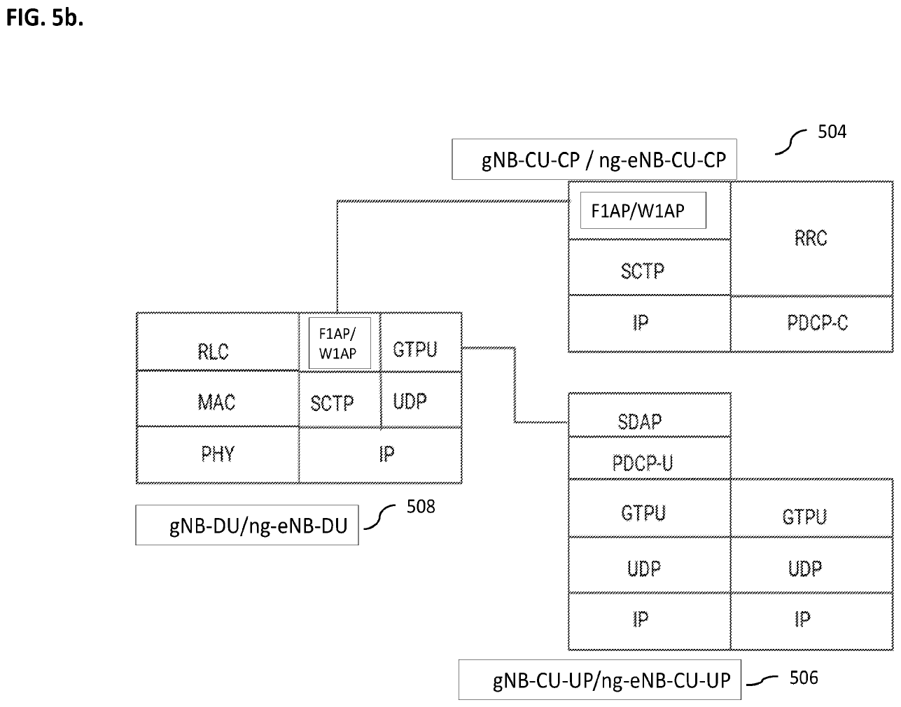

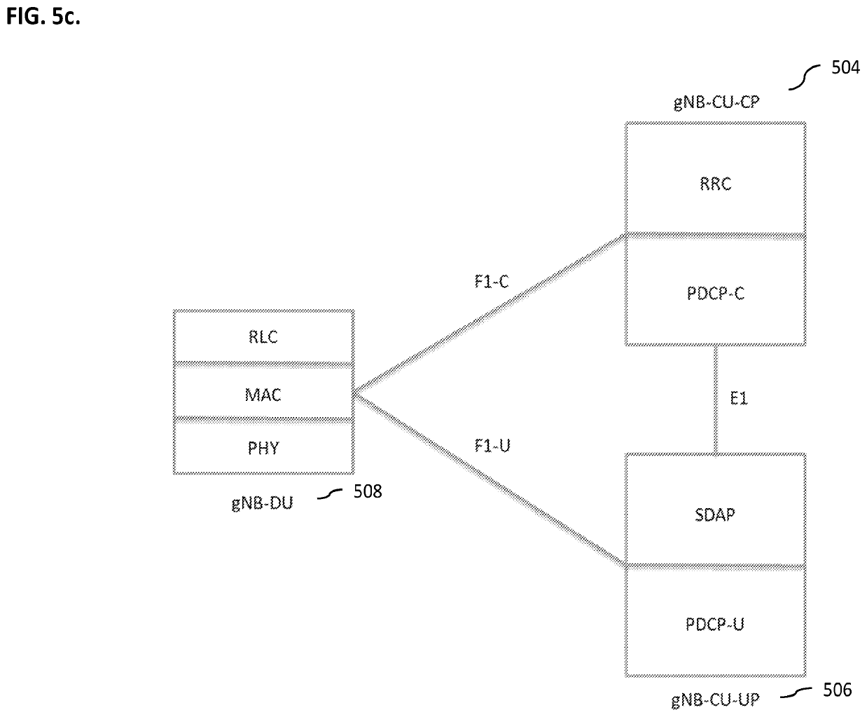

FIG. 5a illustrates an exemplary 5G wireless communication system 500, according to some implementations of the current subject matter. The system 500 can be configured to have a lower layer split architecture in accordance with Option 7-2. The system 500 can include a core network 502 (e.g., 5G Core) and one or more gNodeBs (or gNBs), where the gNBs can have a centralized unit gNB-CU. The gNB-CU can be logically split into control plane portion, gNB-CU-CP, 504 and one or more user plane portions, gNB-CU-UP, 506. The control plane portion 504 and the user plane portion 506 can be configured to be communicatively coupled using an E1 communication interface 514 (as specified in the 3GPP Standard). The control plane portion 504 can be configured to be responsible for execution of the RRC and PDCP protocols of the radio stack.

The control plane and user plane portions 504, 506 of the centralized unit of the gNB can be configured to be communicatively coupled to one or more distributed units (DU) 508, 510, in accordance with the higher layer split architecture. The distributed units 508, 510 can be configured to execute RLC, MAC and upper part of PHY layers protocols of the radio stack. The control plane portion 504 can be configured to be communicatively coupled to the distributed units 508, 510 using F1-C communication interfaces 516, and the user plane portions 506 can be configured to be communicatively coupled to the distributed units 508, 510 using F1-U communication interfaces 518. The distributed units 508, 510 can be coupled to one or more remote radio units (RU) 512 via a fronthaul network 520 (which may include one or switches, links, etc.), which in turn communicate with one or more user equipment (not shown in FIG. 5a). The remote radio units 512 can be configured to execute a lower part of the PHY layer protocols as well as provide antenna capabilities to the remote units for communication with user equipments (similar to the discussion above in connection with FIGS. 1a-2).

FIG. 5b illustrates an exemplary layer architecture 530 of the split gNB. The architecture 530 can be implemented in the communications system 500 shown in FIG. 5a, which can be configured as a virtualized disaggregated radio access network (RAN) architecture, whereby layers L1, L2, L3 and radio processing can be virtualized and disaggregated in the centralized unit(s), distributed unit(s) and radio unit(s). As shown in FIG. 5b, the gNB-DU 508 can be communicatively coupled to the gNB-CU-CP control plane portion 504 (also shown in FIG. 5a) and gNB-CU-UP user plane portion 506. Each of components 504, 506, 508 can be configured to include one or more layers.

The gNB-DU 508 can include RLC, MAC, and PHY layers as well as various communications sublayers. These can include an F1 application protocol (F1-AP) sublayer, a GPRS tunneling protocol (GTPU) sublayer, a stream control transmission protocol (SCTP) sublayer, a user datagram protocol (UDP) sublayer and an internet protocol (IP) sublayer. As stated above, the distributed unit 508 may be communicatively coupled to the control plane portion 504 of the centralized unit, which may also include F1-AP, SCTP, and IP sublayers as well as radio resource control, and PDCP-control (PDCP-C) sublayers. Moreover, the distributed unit 508 may also be communicatively coupled to the user plane portion 506 of the centralized unit of the gNB. The user plane portion 506 may include service data adaptation protocol (SDAP), PDCP-user (PDCP-U), GTPU, UDP and IP sublayers.

FIG. 5c illustrates an exemplary functional split in the gNB architecture shown in FIGS. 5a-b. As shown in FIG. 5c, the gNB-DU 508 may be communicatively coupled to the gNB-CU-CP 504 and GNB-CU-UP 506 using an F1-C communication interface. The gNB-CU-CP 504 and GNB-CU-UP 506 may be communicatively coupled using an E1 communication interface. The higher part of the PHY layer (or Layer 1) may be executed by the gNB-DU 508, whereas the lower parts of the PHY layer may be executed by the RUs (not shown in FIG. 5c). As shown in FIG. 5c, the RRC and PDCP-C portions may be executed by the control plane portion 504, and the SDAP and PDCP-U portions may be executed by the user plane portion 506.

Some of the functions of the PHY layer in 5G communications network can include error detection on the transport channel and indication to higher layers, FEC encoding/decoding of the transport channel, hybrid ARQ soft-combining, rate matching of the coded transport channel to physical channels, mapping of the coded transport channel onto physical channels, power weighting of physical channels, modulation and demodulation of physical channels, frequency and time synchronization, radio characteristics measurements and indication to higher layers, MIMO antenna processing, digital and analog beamforming, RF processing, as well as other functions.

The MAC sublayer of Layer 2 can perform beam management, random access procedure, mapping between logical channels and transport channels, concatenation of multiple MAC service data units (SDUs) belonging to one logical channel into transport block (TB), multiplexing/demultiplexing of SDUs belonging to logical channels into/from TBs delivered to/from the physical layer on transport channels, scheduling information reporting, error correction through HARQ, priority handling between logical channels of one UE, priority handling between UEs by means of dynamic scheduling, transport format selection, and other functions. The RLC sublayer's functions can include transfer of upper layer packet data units (PDUs), error correction through ARQ, reordering of data PDUs, duplicate and protocol error detection, re-establishment, etc. The PDCP sublayer can be responsible for transfer of user data, various functions during re-establishment procedures, retransmission of SDUs, SDU discard in the uplink, transfer of control plane data, and others.

Layer 3's RRC sublayer can perform broadcasting of system information to NAS and AS, establishment, maintenance and release of RRC connection, security, establishment, configuration, maintenance and release of point-point radio bearers, mobility functions, reporting, and other functions.

### III. Time Synchronization Over Cloud RAN

In some implementations, to the current subject matter may be configured to perform time synchronization of various communication devices, e.g., distributed units, over cloud radio access networks. A controller communicatively coupled to one or more such communication devices may be configured to execute one or more processes associated with time synchronization of such communication devices. The communication devices may be synchronized using one or more phase and/or frequency offsets determined based on one or more timestamps received from one or more communication devices.

For a computing device to synchronize its clock from a timing grand master (which may be based on and/or traceable to a particular primary reference time clock (PRTC)), one or more slave clock algorithms may be used to synchronize its clock using the hardware and/or software components that support synchronization. Phase, time, and/or frequency synchronization processes are governed by IEEE 1588, precision timing protocol (PTP) standard, which may be used to achieve clock synchronization over packet networks in telecommunication radio access network deployments.

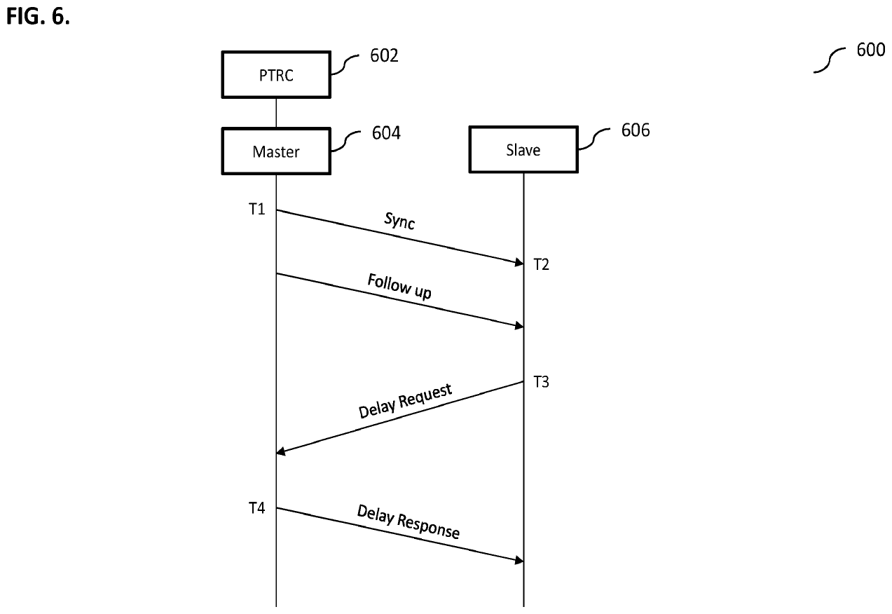

FIG. 6 illustrates an exemplary clock synchronization process 600 that may be performed in accordance with IEEE 1588 standard. The process 600 may include a master node 604 communicatively coupled to a slave node 606. The master device may also be coupled to a primary reference time clock component 602, which may, in turn, be coupled to an antenna (not shown in FIG. 6).

The process 600 may be initiated upon the master node 604 transmitting (e.g., periodically) a SYNC message to the slave node 606. Upon transmission of the SYNC message, the master node's physical interface records a first timestamp, T1. The slave node 606 receives the SYNC message and records a second timestamp, T2, upon the SYNC message arriving at slave node's physical port. The slave node 606 cannot use the timestamp T2 for synchronization purposes due to propagation delays and hence, its clock would be inaccurate.

The slave node 606 may then execute a frequency lock of its clock to the clock of the master node 604. During this part, the slave node 606 may be configured to only receive SYNC messages until it determined that its timestamp clock is changing at the same rate as the timestamp clock of the master node 604. Once the frequencies are locked, the slave node 606 may be configured to determined delay between the master node 604 and the slave node 606.

To determine delay, the slave node 606 may transmit a DELAY REQUEST message to the master node 604. The slave node 606 may record a timestamp, T3, upon transmission of this message, and wait for a response from the master node 604. The master node 604 may receive the DELAY REQUEST message and record the timestamp, T4, upon receipt of the message at its physical interface. Using the T4 timestamp, the master node 604 may transmit a DELAY RESPONSE message to the slave node 606 that may include the recorded T4 timestamp. Upon receipt of the DELAY RESPONSE message, the slave node 606 may extract the T4 timestamp and determine a reverse delay as (T4-T3). The slave node 606 may then adjust its timestamp clock to account for the delay. After several iterations of this process, the slave node may determine a forward delay using (T2-T1). Using the IEEE 1588 standard, both forward and reverse path delays may be used to account for a wire delay. The delay is referred to as a mean path delay and determined using ((T4-T3)+(T2-T1))/2. Using this determination, the slave node 606 may readjust its clock to align with the master node's 604 clock which now accounts for the wire delay.

With the evolution of cloud radio access networks (RANs) and/or distributed RANs, and depending upon a type of L1/L2/radio splits, synchronization may be needed for various communication devices that form part of such networks, such as, for example, distributed units (DUs) and radio unit (RUS). Such synchronization is important for maintaining symbol timings, synchronization for radio frequency (RF) modules, and other purposes. Cloud based RAN environments/deployments typically include a multitude (e.g., several thousands) RAN devices and, thus, distributing timing information and/or performing synchronization of all such devices using conventional methodology (e.g., using process 600 shown in FIG. 6) is not only challenging but may be ineffective. In view of the number of communication devices requiring synchronization, management and synchronization of time across all devices becomes very burdensome and expensive for network operators.

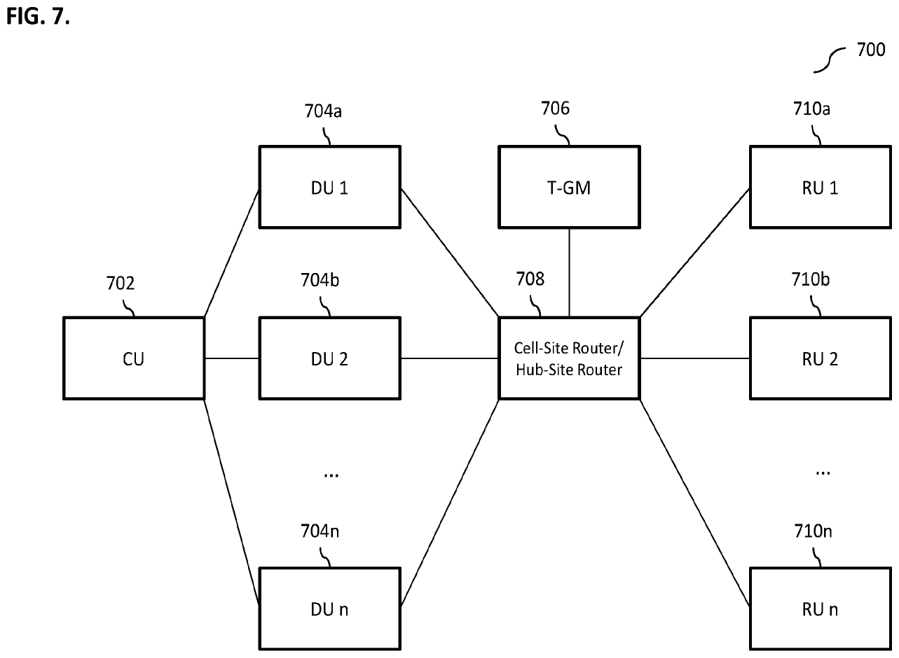

FIG. 7 illustrates an exemplary system 700 that performs distribution and processing associated with clock/timing synchronization across various communication devices. The system 700 may be a radio access network operating in a wireless communication environment (e.g., 4G, LTE, 5G, etc.). The system 700 may include a centralized unit (CU) 702, one or more distributed units (DU1, DU2, . . . DUn) 704 (a, b, . . . n), a timing grandmaster (T-GM) 706, a cell-site router/hub-site router 708, and one or more radio units (RU1, RU2, . . . , RUn)) 710 (a, b, . . . , n).

The CU 702 may be communicatively coupled to each of the DUs 704. The DUs 704 may be communicatively coupled to the router 708 that may provide signal routing capabilities and may communicatively couple the DUs 704 to one or more RUs 710. The router 708 may also be communicatively coupled to the timing grandmaster 706. Each DU 704 may be configured as telecom time slave clock (T-TSC) in relation to the timing grandmaster 706.

The system 700 may include one or more synchronization masters that may be selected for each of the network segments in the system, where a root timing reference is referred to as a grandmaster, e.g., the timing grandmaster 706. The grandmaster may transmit synchronization information to the clocks residing on its network segment, whereby, upon selection of a grandmaster, all other clocks may synchronize directly to it. A precision time protocol (PTP) (as originally defined in IEEE 1588 standard discussed above) may be used to synchronize clocks throughout the system 700. The PTP can be used to achieve clock accuracy in a sub-microsecond range. In some cases, both the DUs 704 and RUs 710 may be configured to use PTP protocol for the purposes of clock synchronization.

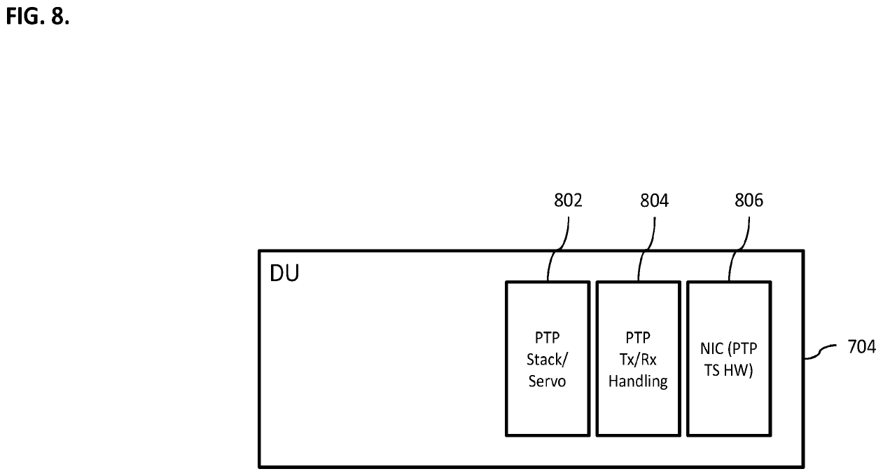

To execute synchronization, each DU 704 may be configured to include various components. FIG. 8 illustrates an exemplary DU 704 and its synchronization components. As shown in FIG. 8, the DU 704 may include a PTP stack servo component 802, a PTP tx/rx handling component 804, and a network interface card (NIC) 806. The PTP stack servo component 802 may be configured to execute various radio control servo software functionalities associated with DU 704 functions. The PTP tx/rx handling component 804 may be configured to execute various software functionalities associated with transmitting and/or receiving of signals from CU 702 (as shown in FIG. 7) and/or RUs 710 (as shown in FIG. 7). The component 806 may be a hardware component that may perform various timestamping processes associated with synchronization of DU clocks (as described above with regard to FIG. 6).

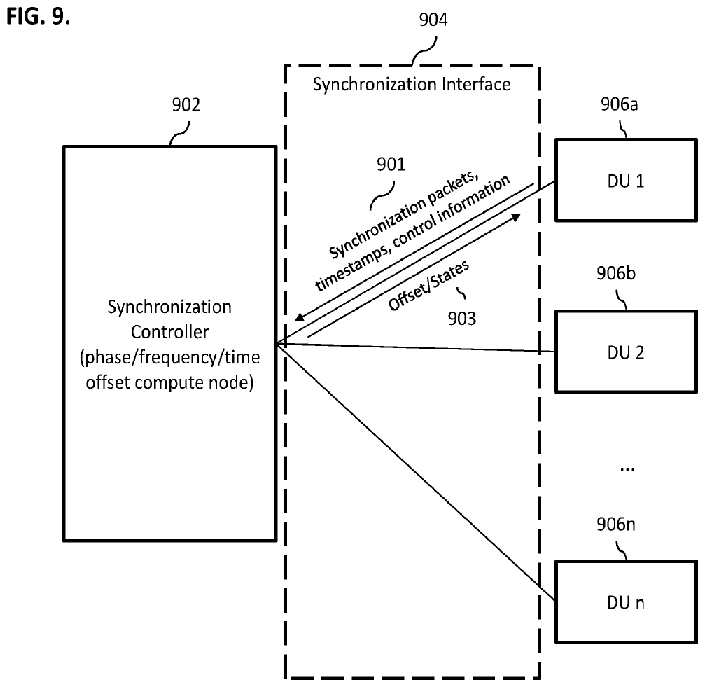

FIG. 9 illustrates an exemplary synchronization system 900, according to some implementations of the current subject matter. The system 900 may be configured to execute clock synchronization algorithms for synchronizing clocks across one or more communication components (e.g., distributed units). The system 900 may include a synchronization controller component 902, a synchronization interface 904, and one or more distributed units 906 (a, b, . . . , n). The distributed units 906 may be similar to distributed units 704 shown in FIG. 7. The system 900 may be implemented as a cloud-based radio access network. The synchronization controller 902 may be hosted on a server and may be communicatively coupled via the synchronization interface 904 to one or more distributed units 906. The synchronization interface 904 may be time-sensitive to minimize transmission delays between the controller 902 and DUs 906. In some exemplary implementations, the controller 902 may be physically co-located with the DUs 906.

Using the system 900, the current subject matter may be configured to provide for a separate handling of timing and/or synchronization packets and determining phase, frequency, and/or time offsets. In particular, the controller 902 may be configured to execute determinations of phase, frequency, and/or time offsets for each of the DUs 906 based on timing and synchronization packets (as well as other control information/data) received from each DU 906. Each DU 906 may perform PTP/synchronous-Ethernet (SyncE) packets processing and handling (e.g., transmission and/or reception), including extraction of one or more timestamps and/or other control information from such PTP/synchronous-Ethernet (SyncE) packets that are received from one or more external sources (e.g., master clock devices, etc.). In addition to determining offsets based on the received timestamps, the controller 902 may be configured to determine a timing state machine of respective DUs 906 based on the control information earlier transmitted by that DU 906. The determined offsets by the controller 902 may be provided and/or transmitted to each respective DU 906 for the purposes of synchronizing the DU 906's hardware (e.g., network interface card) so that it may be traceable to the primary reference time clock, thereby achieving clock synchronization. The controller 902 may be configured to determine synchronization state of each DU 906 based on the specific information (e.g., timestamps) provided by each respective DU 906.

As shown in FIG. 9, each DU 906 may be configured transmit one or more communication parameters, which may include one or more timestamps associated with one or more synchronization packets generated by the DUs 906, where the synchronization packets may be processed by the DUs 906 upon receiving PTP/synchronous-Ethernet (SyncE) packets from one or more external clock sources (e.g., timing grandmaster). As stated above, the timestamps may be extracted from synchronization packets by the DUs 906. The timestamps along with various control information (e.g., to control operation of the DU 906) may be transmitted via the time-sensitive synchronization interface 904 to the controller 902. The control data may include at least one of: one or more precision timing protocol data packets generated by the DUs 906, one or more synchronous Ethernet data packets generated by DUs 906, and any combination thereof.

The controller 902 may then determine one or more synchronization parameters for each of the DU 906 based on the based on the received communication parameters. The synchronization parameters may include one or more offsets, e.g., a timing offset, a frequency offset, and/or a phase offset. Such offsets may be individually determined for each DU 906.

The controller 902 may then transmit the determined synchronization parameters to each respective DU 906. The controller 902 may then synchronize clocks of each of the DU 906 using the synchronization parameters. In some implementations, the controller 902 may be configured to determine a sector status of each DU 906 based on the determined synchronization parameters. The synchronized DUs 906 may then transmit data packets to other communication devices (e.g., CUs, RUs, etc.) and/or user equipments (not shown in FIG. 9).

In some implementations, the current subject matter may have one or more of the following advantages. In particular, the current subject matter may be configured to avoid unnecessary cost for network operators associated with payment for timing stack/servo licenses for each distributed unit needing clock synchronization. Instead, the controller 902 may provide a centralized timing stack/servo processing of synchronization packets and offsets determination, thereby only a single license associated with operation of the controller 902 may need to be obtained and paid for by network operators. Further, the current subject matter may be configured to allow network operators to select any synchronization/timing hardware (e.g., NICs) vendors supporting synchronization client processing. The current subject matter may also provide assistance in management of synchronization plane on each DU 906 by centrally monitoring the controller 902 to detect any synchronization failures and execute corrective actions immediately without impacting network operator key performance indicators.

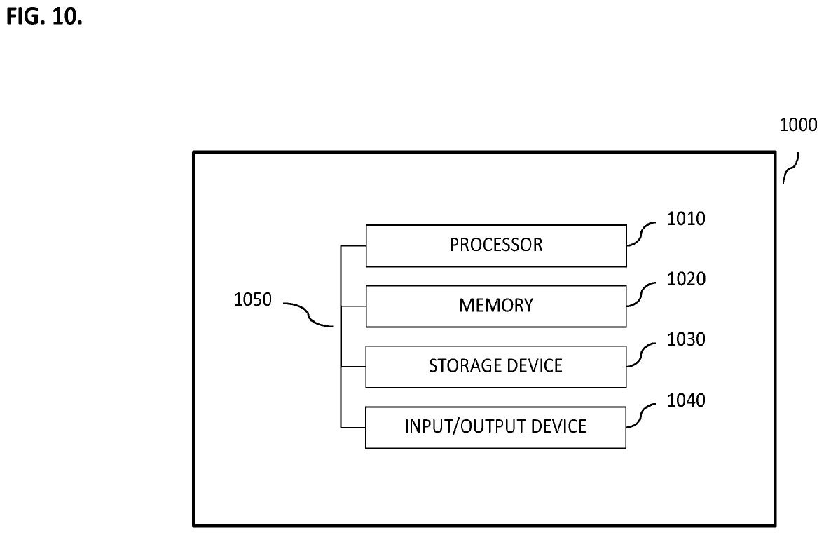

In some implementations, the current subject matter can be configured to be implemented in a system 1000, as shown in FIG. 10. The system 1000 can include one or more of a processor 1010, a memory 1020, a storage device 1030, and an input/output device 1040. Each of the components 1010, 1020, 1030 and 1040 can be interconnected using a system bus 1050. The processor 1010 can be configured to process instructions for execution within the system 600. In some implementations, the processor 1010 can be a single-threaded processor. In alternate implementations, the processor 1010 can be a multi-threaded processor. The processor 1010 can be further configured to process instructions stored in the memory 1020 or on the storage device 1030, including receiving or sending information through the input/output device 1040. The memory 1020 can store information within the system 1000. In some implementations, the memory 1020 can be a computer-readable medium. In alternate implementations, the memory 1020 can be a volatile memory unit. In yet some implementations, the memory 1020 can be a non-volatile memory unit. The storage device 1030 can be capable of providing mass storage for the system 1000. In some implementations, the storage device 1030 can be a computer-readable medium. In alternate implementations, the storage device 1030 can be a floppy disk device, a hard disk device, an optical disk device, a tape device, non-volatile solid state memory, or any other type of storage device. The input/output device 1040 can be configured to provide input/output operations for the system 1000. In some implementations, the input/output device 1040 can include a keyboard and/or pointing device. In alternate implementations, the input/output device 1040 can include a display unit for displaying graphical user interfaces.

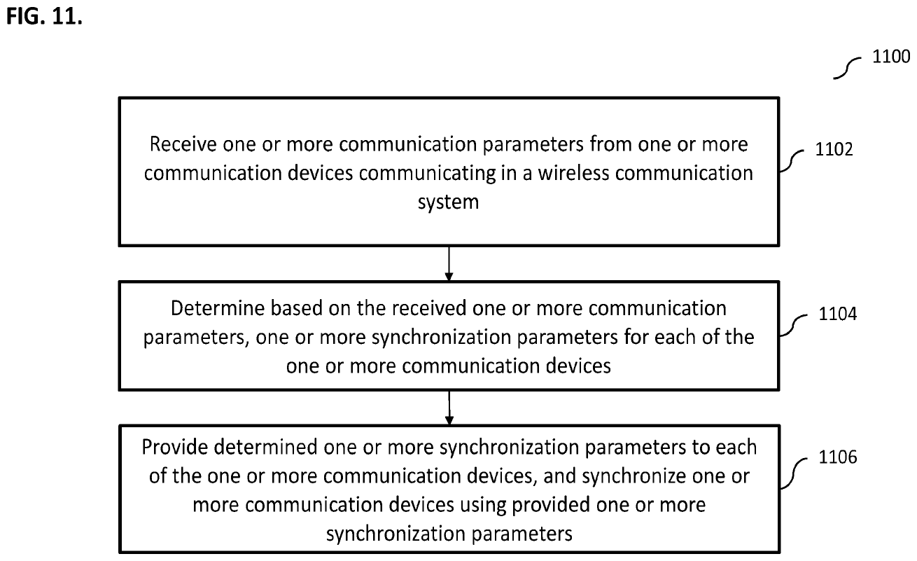

FIG. 11 illustrates an exemplary method 1100 for performing clock synchronization in a wireless communication system (e.g., a cloud-based radio access network), according to some implementations of the current subject matter. The method 1100 may be executed using system 900 shown in FIG. 9 and in particular, the controller 902, which may include any combination of hardware and/or software (e.g., a processor and/or at least one memory). At 1102, the controller 902 may be configured to receive one or more communication parameters (e.g., synchronization packet timestamps, controller information) from one or more communication devices (e.g., distributed units 906) communicating in a wireless communication system. The controller 902 may then determine, based on the received communication parameters, one or more synchronization parameters (e.g., time, frequency, and/or phase offsets) for each of one or more communication devices, at 1104. At 1106, the controller 902 may provide and/or transmit the determined synchronization parameters to each of the communication devices. The controller 902 may use such synchronization parameters to synchronize each communication device.

In some implementations, the current subject matter may include one or more of the following optional features. One or more communication parameters may include one or more timestamps associated with one or more synchronization packets generated by one or more communication devices, one or more timestamps being extracted from one or more synchronization packets by one or more communication devices. One or more communication parameters may include one or more control data packets associated with controlling operation of the one or more communication devices. One or more control data packets may be extracted from at least one of: one or more precision timing protocol data packets generated by one or more communication devices, one or more synchronous Ethernet data packets generated by one or more communication devices, and any combination thereof.

In some implementations, one or more synchronization parameters may include at least one of the following: a phase, a frequency, a timing offset and any combination thereof associated with each of one or more communication devices.

In some implementations, the method 1100 may also include determining a sector status of one or more communication devices based on determined one or more synchronization parameters.

In some implementations, one or more communication devices may be configured to transmit one or more data packets based on the synchronizing.

In some implementations, one or more communication devices may include at least one of the following: a base station, a gNodeB base station, an eNodeB base station, and any combination thereof. One or more communication devices may include at least one of the following: one or more distributed units, one or more radio units, and any combinations thereof. The base station may be a base station operating in at least one of the following communications systems: a long term evolution communications system and a new radio communications system.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer implemented method, comprising:
receiving, using at least one processor, one or more communication parameters from one or more communication devices communicating in a wireless communication system;
determining, using the at least one processor, based on the received one or more communication parameters, one or more synchronization parameters for each of the one or more communication devices; and
providing, using the at least one processor, the determined one or more synchronization parameters to each of the one or more communication devices, and synchronizing the one or more communication devices using the provided one or more synchronization parameters.

2. The method according to claim 1, wherein the one or more communication parameters include one or more timestamps associated with one or more synchronization packets generated by the one or more communication devices, the one or more timestamps being extracted from the one or more synchronization packets by the one or more communication devices.

3. The method according to claim 2, wherein the one or more communication parameters include one or more control data packets associated with controlling operation of the one or more communication devices.

4. The method according to claim 3, wherein the one or more control data packets are extracted from at least one of: one or more precision timing protocol data packets generated by the one or more communication devices, one or more synchronous Ethernet data packets generated by the one or more communication devices, and any combination thereof.

5. The method according to claim 1,
wherein the one or more synchronization parameters include at least one of the following: a phase, a frequency, a timing offset and any combination thereof associated with each of the one or more communication devices.

6. The method according to claim 1, further comprising determining a sector status of the one or more communication devices based on the determined one or more synchronization parameters.

7. The method according to claim 1, wherein the one or more communication devices are configured to transmit one or more data packets based on the synchronizing.

8. The method according to claim 1, wherein the one or more communication devices include at least one of the following: a base station, a gNodeB base station, an eNodeB base station, and any combination thereof.

9. The method according to claim 8, wherein the one or more communication devices include at least one of the following: one or more distributed units, one or more radio units, and any combinations thereof.

10. The method according to claim 9, wherein the base station is a base station operating in at least one of the following communications systems: a long term evolution communications system and a new radio communications system.

11. A system, comprising:
at least one processor, and
at least one non-transitory storage media storing instructions that, when executed by the at least one processor, cause the at least one processor to perform operations of any-of-the-preceding comprising:
receiving, using at least one processor, one or more communication parameters from one or more communication devices communicating in a wireless communication system:
determining, using the at least one processor, based on the received one or more communication parameters, one or more synchronization parameters for each of the one or more communication devices; and
providing, using the at least one processor, the determined one or more synchronization parameters to each of the one or more communication devices, and synchronizing the one or more communication devices using the provided one or more synchronization parameters.

12. At least one non-transitory storage media storing instructions that, when executed by at least one processor, cause the at least one processor to perform operations comprising:
receiving, using at least one processor, one or more communication parameters from one or more communication devices communicating in a wireless communication system;
determining, using the at least one processor, based on the received one or more communication parameters, one or more synchronization parameters for each of the one or more communication devices; and
providing, using the at least one processor, the determined one or more synchronization parameters to each of the one or more communication devices, and synchronizing the one or more communication devices using the provided one or more synchronization parameters.

13. The system according to claim 11, wherein the one or more communication parameters include one or more timestamps associated with one or more synchronization packets generated by the one or more communication devices, the one or more timestamps being extracted from the one or more synchronization packets by the one or more communication devices.

14. The system according to claim 13, wherein the one or more communication parameters include one or more control data packets associated with controlling operation of the one or more communication devices.

15. The system according to claim 14, wherein the one or more control data packets are extracted from at least one of: one or more precision timing protocol data packets generated by the one or more communication devices, one or more synchronous Ethernet data packets generated by the one or more communication devices, and any combination thereof.

16. The system according to claim 11, wherein the one or more synchronization parameters include at least one of the following: a phase, a frequency, a timing offset and any combination thereof associated with each of the one or more communication devices.

17. The system according to claim 11, wherein the operations further comprise determining a sector status of the one or more communication devices based on the determined one or more synchronization parameters.

18. The system according to claim 11, wherein the one or more communication devices are configured to transmit one or more data packets based on the synchronizing.

19. The system according to claim 11, wherein the one or more communication devices include at least one of the following: a base station, a gNodeB base station, an eNodeB base station, and any combination thereof.

20. The system according to claim 11, wherein the one or more communication devices include at least one of the following: one or more distributed units, one or more radio units, and any combinations thereof; and
the base station is a base station operating in at least one of the following communications systems: a long term evolution communications system and a new radio communications system.
